(19) United States
(12) Patent Application Publication
(10) Pub. No.: US 2012/0254906 A1
(43) Pub. Date: Oct. 4, 2012

(54) MOVIE RECOMMENDATION SYSTEM AND MOVIE RECOMMENDATION METHOD

(75) Inventors: Kazushige HIROI, Machida (JP); Masato SUZUKI, Yokohama (JP); Takanori EDA, Yokohama (JP)

(73) Assignee: HITACHI CONSUMER ELECTRONICS CO., LTD., Tokyo (JP)

(21) Appl. No.: 13/346,985

(22) Filed: Jan. 10, 2012

(30) Foreign Application Priority Data
Mar. 28, 2011 (JP) 2011-069362

(51) Int. Cl. H04N 21/258; H04N 21/24

(52) U.S. Cl. 725/9

(57) ABSTRACT

It is provided a movie recommendation system comprising a log holding unit a movie information input unit including a movie basic information input unit and a movie extended information input unit, and a recommendation calculation unit including a simple recommendation calculation unit and an extended recommendation calculation unit. The movie recommendation system compares the number of the operation logs held in the log holding unit and a predetermined value, calculates the recommendation movies by the simple recommendation calculation unit in a case where it is determined that a small number of operation logs are held in the log holding unit, and calculates the recommendation movies by the extended recommendation calculation unit in a case where it is determined that a large number of operation logs are held in the log holding unit.

### CLAIM OF PRIORITY

The present application claims priority from Japanese patent application JP 2011-69362 filed on Mar. 28, 2011, the content of which is hereby incorporated by reference into this application.

### BACKGROUND OF THE INVENTION

The present invention relates to movie recommendation system and method for recommending movie contents suited to user's tastes.

In recent years, viewable movie contents such as terrestrial digital broadcasting, BS broadcasting, CS broadcasting and Internet movie delivery have been on the increase in movie viewing equipment such as televisions and it has become difficult to search desired movies. Thus, a technology for analyzing user's tastes from user's operation logs on movies and recommending user's favorite movies according to the analyzed tastes is effective.

In a conventional movie recommendation technology, user's tastes are normally extracted based on keywords and genres included in operated movie information from user's operation logs on movies (viewing, recording, reproduction history and the like of movies) and movies matching the extracted tastes are recommended. Thus, normally, no movies can be recommended until operation logs on movies sufficient to enable taste extraction are accumulated. For this reason, for example, JP 2010-2944 A discloses a method and an apparatus capable of recommending movies even in the absence of operation logs of a user on movies by recommending popular movies in accordance with tastes based on operation logs of the others on movies even if this user's tastes cannot be extracted.

### SUMMARY OF THE INVENTION

As described above, in the conventional movie recommendation technology, it is difficult to recommend suitable movies until the operation logs of the user on movies are sufficiently accumulated. Thus, there has been a problem that no movies are recommended or recommendation movies are not suitable particularly for a certain period from an initial state. In this case, there is a problem that the user has to perform a movie operation for a while after purchasing movie viewing equipment and wait for movie recommendation until a period necessary to sufficiently accumulate operation logs elapses.

On the other hand, according to conventional technologies such as disclosed in JP 2010-2944 A, movies can be recommended even before the operation logs of the user on movies are sufficiently accumulated, but movies to be recommended are those based on the others' tastes or those popular among many people (based on ranking), wherefore there is a problem that movies suited to a target user himself are not recommended. In these conventional technologies, a movie recommendation system needs to be connected to a network to obtain information on others' tastes. Thus, such problems cannot be solved in apparatuses such as TV receivers and recorders which are not network-connected and there is a problem of increasing apparatus cost.

It is an object of this invention to accurately recommend movies suited to user's tastes and effectively recommend movies in a case where there are a small number of operation logs of the user on movies.

The representative one of inventions disclosed in this application is outlined as follows. There is provided a movie recommendation system for recommending movies to a user, comprising: a log holding unit for holding at least one operation log of viewing, recording, reproducing and programming by the user on a movie; a movie information input unit for receiving the input of information on movies operable by the user; and a recommendation calculation unit for calculating recommendation movies to be recommended to the user based on the operation logs held in the log holding unit and movie information input to the movie information input unit. The movie information input unit includes a movie basic information input unit for receiving the input of basic information on the movies operable by the user and a movie extended information input unit for receiving the input of extended information on the movies operable by the user. The recommendation calculation unit includes a simple recommendation calculation unit for calculating recommendation movies based on the basic information input to the movie basic information input unit and an extended recommendation calculation unit for calculating recommendation movies based on the extended information input to the movie extended information input unit. The movie recommendation system compares the number of the operation logs held in the log holding unit and a predetermined value, calculates the recommendation movies by the simple recommendation calculation unit in a case where it is determined that a small number of operation logs are held in the log holding unit, and calculates the recommendation movies by the extended recommendation calculation unit in a case where it is determined that a large number of operation logs are held in the log holding unit.

According to a representative embodiment of the present invention, movies suited to user's tastes can be accurately recommended.

### BRIEF DESCRIPTION OF THE DRAWINGS

The present invention can be appreciated by the description which follows in conjunction with the following figures, wherein:

FIG. 1 is a block diagram showing an example of hardware configuration of a movie recommendation system according to this embodiment;

FIG. 2 is a functional block diagram of an example of the movie recommendation system according to this embodiment;

FIG. 3 is a table showing an example of the basic information input to the movie basic information input unit according to this embodiment;

FIG. 4 is a table showing an example of the extended information input to the movie extended information input unit according to this embodiment;

FIG. 5 is a table showing an example of the movie information input to the movie information input unit according to this embodiment;

FIG. 6 is a table showing an example of the operation logs input to the log input unit according to this embodiment;

FIGS. 7A and 7B are tables showing examples of the recommendation calculation result according to this embodiment;

FIG. 8 is a table showing an example of the movie selection screen generated by the movie selection screen generating unit according to this embodiment;

FIG. 9 is a diagram showing an example of a display screen for the recommendation calculation result according to this embodiment;

FIG. 10 is a flow chart of the recommendation calculation process according to this embodiment; and

FIG. 11 is a flow chart of the recommendation result output process according to this embodiment.

### DETAILED DESCRIPTION OF THE PREFERRED EMBODIMENTS

First, an embodiment of the present invention is outlined.

In this embodiment, in a case where operation logs of a user are not accumulated in an initial stage of the operation of a movie recommendation system, a screen for enabling the user to select one or more favorite movies is displayed to tentatively obtain the user's tastes. A recommendation calculation is performed by a simple method using these obtained tastes, and information on recommendation movies is presented based on the calculation result. On the other hand, after the operation logs of the user are sufficiently accumulated, the recommendation calculation is performed by the following method and information on recommendation movies is presented based on the calculation result in a case where there is a request from the user to present the recommendation movies.

That is, the recommendation calculation is performed by a first calculation method (simple recommendation calculation method) in a case of movie recommendation not in the initial stage and operation logs of the user on movies have not reached a predetermined amount. On the other hand, in a case where the operation logs of the user exceed the predetermined amount, the recommendation calculation is performed by a second calculation method (extended recommendation calculation method).

The embodiment of the present invention is described below with reference to the drawings.

### First Embodiment

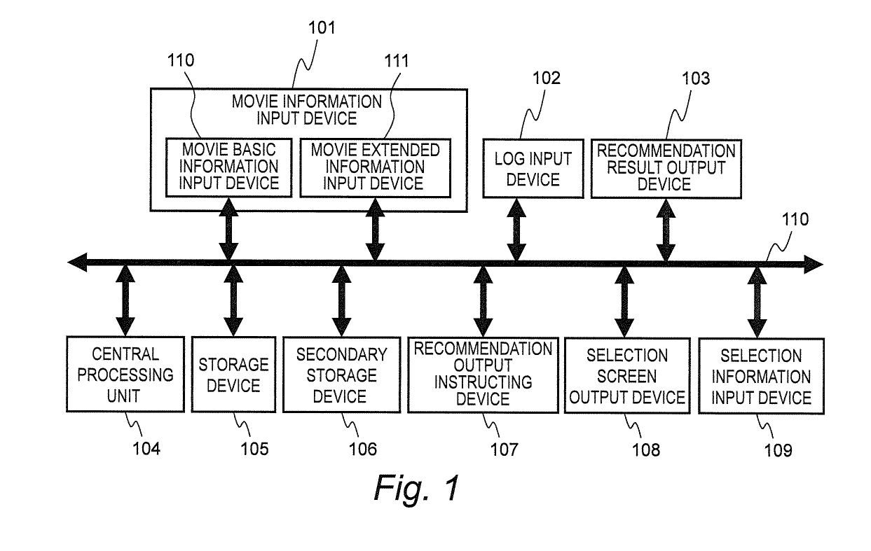

FIG. 1 is a block diagram showing an example of hardware configuration of the movie recommendation system according to this embodiment.

The movie recommendation system of this embodiment can be realized using hardware configuration of a digital television receiver, a hard disk recorder, a video tape recorder, a personal computer, a mobile phone or the like having, for example, at least one function out of viewing, recording, reproducing and programming movie contents, and can be constructed to be built in these apparatuses.

As shown in FIG. 1, the movie recommendation system of this embodiment includes a movie information input device 101 including a movie basic information input device 110 and a movie extended information input device 111, a log input device 102, a storage device 105, a secondary storage device 106, a central processing unit 104, a recommendation output instructing device 107, a recommendation result output device 103, a selection screen output device 108 and a selection information input device 109. The respective devices are connected by a bus 110 so that data are transmitted and received among the respective devices and units.

The movie information input device 101 receives the input of information on movies viewable, recordable, reproducible and/or programmable by a user. It should be noted that an example of movie information is described later. The movie information input device 101 is, for example, configured to read movie information stored in the storage device 105 or the secondary storage device 106 to be described later or to obtain SI (Service Information) input from a tuner unit of a television in the case of receiving television broadcasting. Further, in the case of obtaining movie information via a network, this movie information input device 101 may be configured to be able to obtain movie information from a network interface such as a LAN card.

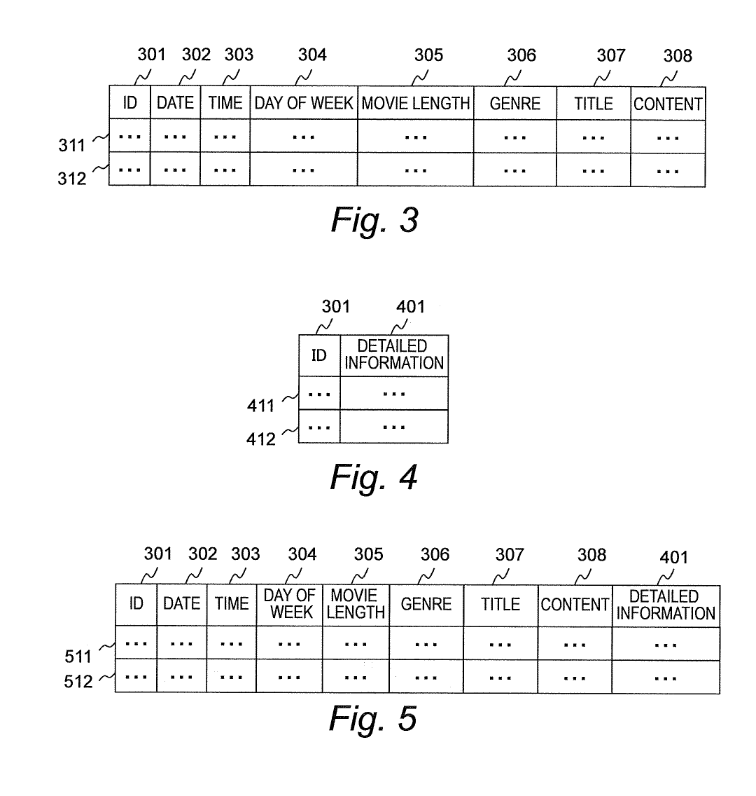

The movie basic information input device 110 is included in the movie information input device 101 and receives the input of movie information, particularly basic information. It should be noted that an example of the basic information is described later using FIG. 3.

The movie extended information input device 111 is included in the movie information input device 101 and receives the input of movie information, particularly extended information. It should be noted that an example of the extended information is described later using FIG. 4.

That is, the movie information input device 101 includes the movie basic information input device 110 and the movie extended information input device 111. The movie information input device 101 receives the movie information including the basic information input to the movie basic information input device 110 and the extended information input to the movie extended information input device 111.

It should be noted that the movie information input device 101 may be configured to obtain these basic information and extended information from one data source or to separately obtain them from a plurality of data sources (e.g. different servers or the like).

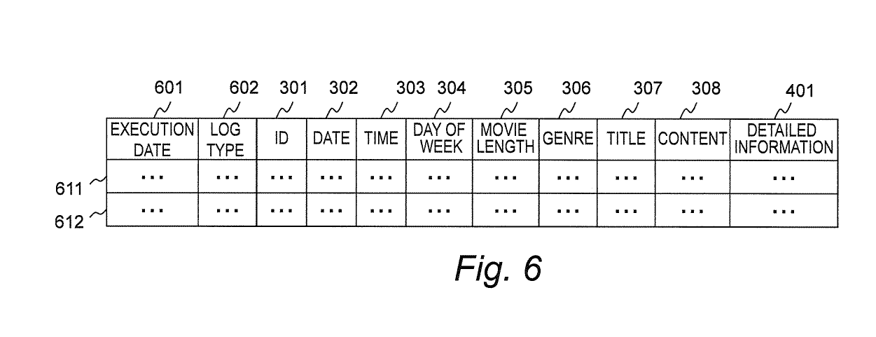

The log input device 102 receives the input of operation logs of the user on viewing, recording, reproducing and/or programming movie contents. It should be noted that examples of the operation logs are described later using FIG. 6. The log input device 102 is so configured that, when an operation of viewing, recording, reproducing or programming a movie is performed in an apparatus such as a television or a recorder, these operations are input to data structures of the operation logs to be described later. Further, when an operation of viewing, recording, reproducing or programming a movie is performed in an apparatus such as a television or a recorder, the storage device 105 or the secondary storage device 106 stores these operations in a format of the operation log to be described later and the log input device 102 is configured to read these pieces of information on the operation logs from the storage device 105 or the secondary storage device 106 when each operation is performed or at a specified timing after each operation is performed (e.g. read a plurality of operations at one time at a specified timing).

The storage device 105 is, for example, a volatile memory (random access memory (RAM) or the like) and stores a program to be executed by the central processing unit 104 and data and the like processed in this movie recommendation system.

The secondary storage device 106 is, for example, a magnetic disk drive, an optical disk drive in which DVDs, CDs or the like can be loaded, or a nonvolatile memory (flash memory or the like), and stores a program to be executed by the central processing unit 104 and data and the like processed in this movie recommendation system. It should be noted that the secondary storage device 106 is an auxiliary storage device for assisting the storage device 105, and the storage device 105 can fulfill the function of the secondary storage device 106 by using a nonvolatile storage element as the storage device 105 or adding a data backup function when a power supply is off to the storage device 105. In this case, the secondary storage device 106 may not be provided.

The central processing unit 104 is mainly composed of a microprocessor and executes the program stored in the storage device 105 (or read from the secondary storage device 106 and stored in the storage device 105) and controls the operation of this movie recommendation system such as by calculating recommendation target movies.

The recommendation output instructing device 107 is configured to receive the input of a request of a user to recommend movies. This means, for example, electrical wiring to transmit an instruction given by the user pressing down a movie recommendation display button of an apparatus such as a television receiver or a personal computer using a remote controller, a mouse or the like to the movie recommendation system. Further, the recommendation output instructing device 107 is configured to issue an interrupt or an event to the central processing unit 104 in terms of software by this operation. The central processing unit 104 recognizes the instruction of a movie recommendation display request from the user based on these interrupt and event.

The recommendation result output device 103 outputs a movie recommendation result in a format to present recommendation movies calculated by the movie recommendation system of this embodiment to the user. This is, for example, configured to output a signal in a format capable of displaying information on the recommendation movies calculated by the central processing unit 104 of the movie recommendation system of this embodiment on a display apparatus such as a television receiver. The recommendation result output device 103 can be realized by a conventional technology such as a configuration to generate a display screen to be shown to the user based on the information on the recommendation movies calculated by the central processing unit 104 and to generate a signal used to write the display screen in a video RAM or the like or display it on a screen of a television receiver, a personal computer or the like.

As described later, the selection screen output device 108 outputs a movie selection screen (see FIG. 8) used by the user to select a favorite movie in a case where there are a small number of operation logs of the user (e.g. in a case where there is not even one operation log or the number of the operation logs is equal to or smaller than a predetermined number) when the output of the recommendation calculation result is requested. The selection screen output device 108 is configured to output a signal in a format capable of displaying a screen generated by the central processing unit 104 of the movie recommendation system of this embodiment and used for movie selection on a display apparatus such as a television receiver. The selection screen output device 108 can be realized by a conventional technology such as a configuration to generate a display screen to be shown to the user based on information generated by the central processing unit 104 and used for movie selection and to generate a signal used to write the display screen in a video RAM or the like or display it on a screen of a television receiver, a personal computer or the like.

The selection information input device 109 receives the input of information on the movie selected by the user on the movie selection screen output by the selection screen output device 108. This may be, for example, configured to issue an interrupt or an event so as to obtain the information on the movie selected by the user from the movie selection screen displayed on an apparatus such as a television receiver or a personal computer using a remote controller, a mouse or the like. The central processing unit 104 processes these interrupt and event.

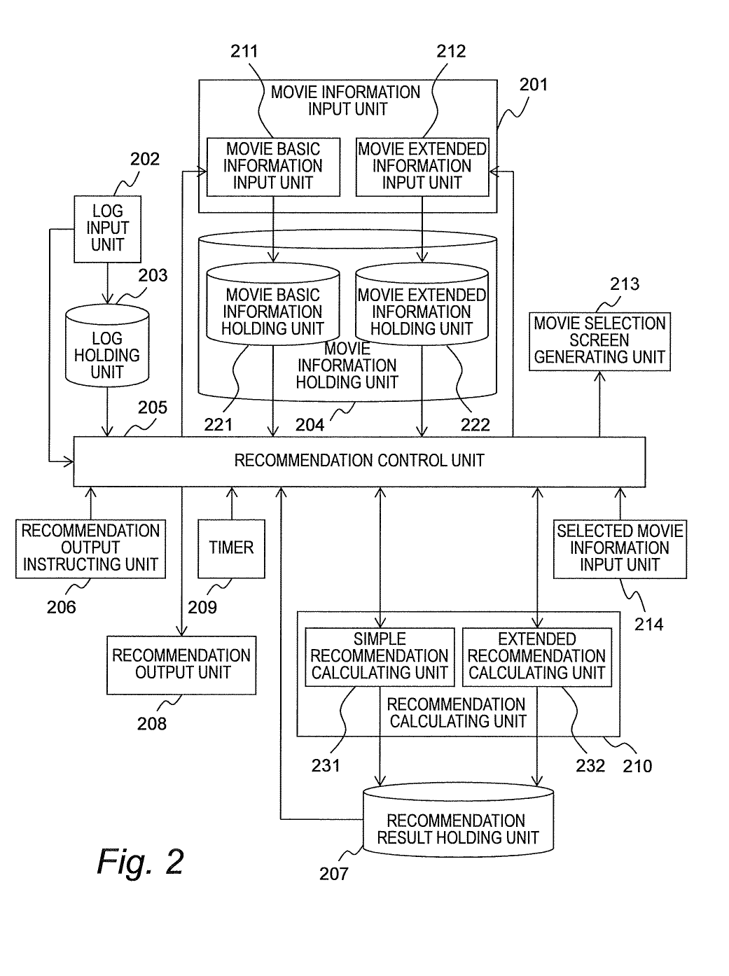

FIG. 2 is a functional block diagram of an example of the movie recommendation system of this embodiment. Functional blocks shown in FIG. 2 are mounted by the central processing unit 104 executing the program stored in the storage device 105, but some or all of them may be mounted by a hardware logic or firmware.

As shown in FIG. 2, the movie recommendation system according to this embodiment includes a movie information input unit 201 with a movie basic information input unit 211 and a movie extended information input unit 212, a movie information holding unit 204 with a movie basic information holding unit 221 and a movie extended information holding unit 222, a log input unit 202, a log holding unit 203, a movie selection screen generating unit 213, a selected movie information input unit 214, a timer 209, a recommendation calculating unit 210 with a simple recommendation calculating unit 231 and an extended recommendation calculating unit 232, a recommendation result holding unit 207, a recommendation output instructing unit 206, a recommendation output unit 208 and a recommendation control unit 205.

The movie information input unit 201 is a software part of the movie information input device 101 and processes information on movies viewable, recordable, reproducible and/or programmable by the user input to the movie information input device 101 based on an instruction from the recommendation control unit 205.

The movie basic information input unit 211 is a software part of the movie basic information input device 110 and included in the movie information input unit 201, and particularly receives the input of basic information from the movie basic information input device 110 out of the movie information based on an instruction from the recommendation control unit 205. It should be noted that an example of the basic information is described later using FIG. 3.

The movie extended information input unit 212 is a software part of the movie extended information input device 111 and included in the movie information input unit 201, and particularly receives the input of movie extended information from the movie extended information input device 111 out of the movie information based on an instruction from the recommendation control unit 205. It should be noted that an example of the extended information is described later using FIG. 4.

That is, the movie information input unit 201 includes the movie basic information input unit 211 and the movie extended information input unit 212 and receives the information with the basic information input to the movie basic information input unit 211 and the extended information input to the movie extended information input unit 212.

The movie information holding unit 204 is composed of a storage area of the storage device 105 or the secondary storage device 106 for holding the movie information input to the movie information input unit 201 and a functional block for reading and writing data in and from this storage area.

The movie basic information holding unit 221 is included in the movie information holding unit 204 and composed of a storage area of the storage device 105 or the secondary storage device 106 for particularly holding the basic information input to the movie basic information input unit 211 out of the movie information and a functional block for writing and reading data in and from this storage area.

The movie extended information holding unit 222 is included in the movie information holding unit 204 and composed of a storage area of the storage device 105 or the secondary storage device 106 for particularly holding the extended information input to the movie extended information input unit 212 out of the movie information and a functional block for writing and reading data in and from this storage area.

That is, the movie information holding unit 204 includes the movie basic information holding unit 221 and the movie extended information holding unit 222 and is composed of the storage areas of the storage device 105 and the secondary storage device 106 for holding the movie information with the basic information input to the movie basic information input unit 211 and the extended information input to the movie extended information input unit 212 and the functional blocks for writing and reading data in these storage areas.

The log input unit 202 is a software part of the log input device 102 and processes the information on the operation logs of the user on viewing, recording, reproducing and/or programming movies input to the log input device 102. Further, the log input unit 202 notifies information on an operation input by the user to the recommendation control unit 205 together with information on an operated movie.

The log holding unit 203 is composed of a storage area of the storage device 105 or the secondary storage device 106 for holding the operation logs of the user on viewing, recording, reproducing and/or programming movies input to the log input unit 202 and a functional block for writing and reading data in and from this storage area.

The movie selection screen generating unit 213 is a software part of the selection screen output device 108 and generates a movie selection screen (see FIG. 8) used by the user to select a favorite movie in a case where there are a small number of operation logs in the log holding unit 203 (e.g. in a case where there is not even one operation log or the number of the operation logs is equal to or smaller than a predetermined number) when a request to output a recommendation calculation result is given from the recommendation output instructing unit 206 to the recommendation control unit 205. The movie selection screen generating unit 213 is, for example, configured to generate the movie selection screen based on the movie information input to the movie information input unit 201. Using this movie selection screen, the user can select a movie of interest. At this time, the movie selection screen can be quickly generated particularly in a case where the movie selection screen is generated based on the basic information input to the movie basic information input unit 211. The movie selection screen generated by the movie selection screen generating unit 213 is output from the selection screen output device 108.

The selected movie information input unit 214 is a software part of the selection information input device 109 and processes the information, on the movie selected by the user on the movie selection screen generated by the movie selection screen generating unit 213, input to the selection information input device 109. Specifically, the selected movie information input unit 214 notifies the information on the selected movie to the recommendation control unit 205.

The timer 209 is a clock for measuring the current time and regularly notifies it to the recommendation control unit 205. Notification to the recommendation control unit 205 is used as a trigger for recommendation calculation by the recommendation calculating unit 210. Notification to the recommendation control unit 205 can be realized, for example, by a timer interrupt, an event and the like. The timer 209 can be realized by a timer (e.g. real time clock) pre-mounted in many apparatuses such as television receivers and personal computers.

The recommendation calculating unit 210 calculates recommendation target movies for the user based on an instruction from the recommendation control unit 205. That is, the recommendation calculating unit 210 obtains the operation logs of the user held in the log holding unit 203 and the movie information held in the movie information holding unit 204 via the recommendation control unit 205 and calculates the recommendation target movies for the user based on the obtained information. More specifically, the recommendation calculating unit 210 calculates a matching degree of the information on each movie held in the movie information holding unit 204 and information on movies included in the operation logs of the user held in the log holding unit 203 (i.e. operated by the user), and calculates a recommendation score of each movie based on the calculated matching degree. It should be noted that score calculation is performed by the simple recommendation calculating unit 231 or the extended recommendation calculating unit 232 according to the number of the operation logs of the user.

The simple recommendation calculating unit 231 is included in the recommendation calculating unit 210 and calculates the recommendation target movies for the user based on an instruction of the recommendation control unit 205. Particularly, in a case where the number of the operation logs of the user is determined to be small (e.g. smaller than a predetermined number), the simple recommendation calculating unit 231 obtains the operation logs of the user held in the log holding unit 203 and the basic information held in the movie basic information holding unit 221 via the recommendation control unit 205 and calculates the recommendation target movies for the user based on the obtained information. Specifically, the simple recommendation calculating unit 231 calculates a matching degree of the basic information held in the movie basic information holding unit 221 with the information on the movies included in the operation logs of the user held in the log holding unit 203 (i.e. operated by the user) and calculates a recommendation score of each movie based on the calculated matching degree. It should be noted that a specific recommendation score calculation method by the simple recommendation calculating unit 231 is described later.

The extended recommendation calculating unit 232 is included in the recommendation calculating unit 210 and operates based on an instruction of the recommendation control unit 205. Particularly, in a case where the number of the operation logs of the user is determined to be large (e.g. larger than a predetermined number), the extended recommendation calculating unit 232 obtains the operation logs of the user held in the log holding unit 203, the basic information held in the movie basic information holding unit 221 and the extended information held in the movie extended information holding unit 222 via the recommendation control unit 205 and calculates the recommendation target movies for the user based on the obtained information. Specifically, the extended recommendation calculating unit 232 calculates a matching degree of the movie information included the basic information held in the basic information holding unit 221 and the extended information held in the movie extended information holding unit 222 with the information on the movies included in the operation logs of the user held in the log holding unit 203 (i.e. operated by the user) and calculates a recommendation score of each movie based on the calculated matching degree. It should be noted that a specific recommendation score calculation method by the extended recommendation calculating unit 232 is described later.

The recommendation result holding unit 207 is composed of a storage area of the storage device 105 or the secondary storage device 106 for holding the recommendation calculation result calculated by the recommendation calculating unit 210 (i.e. the simple recommendation calculating unit 231 and the extended recommendation calculating unit 232) and a functional block for writing and reading data in and from this storage area. It should be noted that an example of the recommendation calculation result is described later.

The recommendation output instructing unit 206 is a software part of the recommendation output instructing device 107 and notifies a movie recommendation output instruction input to the recommendation output instructing device 107 by the user to the recommendation control unit 205. The recommendation output instructing unit 206 is, for example, configured to recognize an instruction given by the user pressing down a movie recommendation display button and the like of an apparatus such as a television receiver or a personal computer using a remote controller, a mouse or the like via the recommendation output instructing device 107 and notify it to the recommendation control unit 205. Specifically, the recommendation output instructing unit 206 is configured to issue an interrupt or an event in a case where the user instructs movie recommendation display using a remote controller or a mouse. The central processing unit 104 can be configured to be able to recognize that a movie recommendation display request has been given from the user and notify it to the recommendation control unit 205 based on these interrupt and event.

The recommendation output unit 208 is a software part of the recommendation result output device 103, operates in response to an instruction from the recommendation control unit 205 based on a recommendation output instruction input by the recommendation output instructing unit 206, receives the recommendation calculation result held in the recommendation result holding unit 207 via the recommendation control unit 205 and outputs it to the recommendation result output device 103. In this way, the information on the recommendation movies can be displayed on an apparatus such as a television.

The recommendation control unit 205 controls the movies of the movie recommendation system of this embodiment. Particularly, the recommendation control unit 205 receives the movie information and the operation logs of the user, performs the recommendation calculation and outputs the recommendation calculation result using events and the like from the log input unit 202, the timer 209 and the recommendation output instructing unit 206 as triggers. It should be noted that details of the processing contents of this recommendation control unit 205 are described in detail later.

Next, data and data structures used in the movie recommendation system of this embodiment are described.

First, an example of the basic information on the movies input to the movie basic information input unit 211 is described.

FIG. 3 is a table showing an example of the basic information input to the movie basic information input unit 211 according to this embodiment.

The basic information is data with registered entries (311, 312, etc.) each including a set of data composed of an ID 301, a date 302, a time 303, a day of week 304, a movie length 305, a genre 306, a title 307 and a content 308 for each movie viewable, recordable, reproducible and/or programmable by the user.

The ID 301 is an identifier capable of uniquely identifying the movie. For example, in the case of a terrestrial digital television program, a unique identifier such as a combination of a network ID, a service ID and an event ID can be used for a certain period.

The date 302 is a viewable date of the movie identified by the ID 301. For example, in the case of a terrestrial digital television program, a value (or character string) indicating a broadcasting day of the movie identified by the ID 301 can be used, and data with which the movie recommendation system can distinguish the viewable date of this movie may be used.

The time 303 is a viewable time of the movie identified by the ID 301. For example, in the case of a terrestrial digital television program, a value (or character string) indicating a broadcast start time of the movie identified by the ID 301 can be used, and data with which the movie recommendation system can distinguish the viewable time of this movie may be used.

The day of week 304 is a viewable day of week of the movie identified by the ID 301 and can be calculated from the date 302.

It should be noted that in the case of a movie to be delivered via a network, delivery start day and time are input as the date 302 and the time 303. Further, in the case of an already delivered movie, the date 302, the time 303 and the day of week 304 may be a special value (e.g. NULL) indicating that the movie is viewable any time.

The movie length 305 is the duration of the movie identified by the ID 301. For example, in the case of a terrestrial digital television program, a value (or character string) indicating a broadcast duration of the movie identified by the ID 301 can be used, and data with which the movie recommendation system can distinguish the duration of this movie may be used.

The genre 306 is the type of the movie identified by the ID 301 and, for example, news, drama or the like. For example, in the case of a terrestrial digital television program, a value (or character string) indicating the genre of the movie identified by the ID 301 can be used as the genre 306, and data with which the movie recommendation system can distinguish the genre of this movie may be used.

The title 307 is the title of the movie identified by the ID 301 and may be a character string indicating the program name of the movie identified by the ID 301, for example, in the case of a terrestrial digital television program.

The content 308 is description of the movie identified by the ID 301 and may be a character string indicating the program content of the movie identified by the ID 301, for example, in the case of a terrestrial digital television program.

It should be noted that these pieces of basic information are included in SI basic information superimposed on broadcasting waves, for example, in the case of a terrestrial digital television program and can be calculated from the SI basic information.

Next, an example of the extended information of the movie input to the movie extended information input unit 212 is described.

FIG. 4 is a table showing an example of the extended information input to the movie extended information input unit 212 according to this embodiment.

The extended information is data with registered entries (411, 412, etc.) each including a set of data composed of an ID 301 and detailed information 401 for each movie viewable, recordable, reproducible and/or programmable by the user.

The ID 301 is an identifier capable of uniquely identifying the movie and the same as the ID 301 of the basic information (FIG. 3). This can relate the basic information and the extended information of each movie.

The detailed information 401 is a character string of detailed description of the movie identified by the ID 301. For example, in the case of a terrestrial digital television program, detailed description including the cast, director, producer, screenwriter, song name, artist name and program content of the movie identified by the ID 301 can be used as such.

It should be noted that these pieces of extended information are included in SI extended information superimposed on broadcasting waves, for example, in the case of a terrestrial digital television program and can be estimated from the SI extended information. It should be noted that the extended information may be obtained from a separately provided meta data server.

In this way, the basic information and the extended information differ in time necessary to obtain the information and data amount. For example, information included in a “program table” displayed on a television receiver, for example, in terrestrial digital broadcasting is basic information and information included in detailed contents of programs is extended information. A transmission interval of the basic information and that of the extended information differ, wherein the basic information can be obtained within several seconds, but it takes several tens of seconds to obtain the extended information.

Next, an example of the movie information input to the movie information input unit 201 is described.

FIG. 5 is a table showing an example of the movie information input to the movie information input unit 201 according to this embodiment.

The movie information includes an ID 301, a date 302, a time 303, a day of week 304, a movie length 305, a genre 306, a title 307, a content 308 and detailed information 401 of a movie, and each entry (511, 512) is a collection of the basic information and the extended information described above for the movie having the same ID 301. That is, the movie information input to the movie information input unit 201 is data including the basic information and the extended information set for each movie viewable, recordable, reproducible and/or programmable by the user.

It should be noted that although the movie information shown in FIG. 5 is compiled in one table format, it may be divided into a plurality of tables.

Next, an example of the operation logs of the user input to the log input unit 202 is described.

FIG. 6 is a table showing an example of the operation logs input to the log input unit 202 according to this embodiment.

The operation log includes an execution date 601, a log type 602, an ID 301, a date 302, a time 303, a day of week 304, a movie length 305, a genre 306, a title 307, a content 308 and detailed information 401 and, every time the user performs an operation such as viewing, recording, reproduction, and/or programming of a movie, an entry (611, 612, etc.) including a set of operation information and information on the operated movie is registered.

The execution date 601 is a date on which the user performed the operation such as viewing, recording, reproduction, and/or programming of a movie.

The log type 602 indicates the type of the operation by the user. It is, for example, a numerical value (or character string) indicating information on viewing, recording, reproduction, programming and the like and may be data with which the movie recommendation system can distinguish the content of the operation by the user.

The ID 301, the date 302, the time 303, the day of week 304, the movie length 305, the genre 306, the title 307, the content 308 and the detailed information 401 are the same as the data included in the movie information (see FIG. 5) and store the information on the movie operated by the user. These are used, for example, to recognize the operation of the user on the movie and to obtain the ID 301 and the like of the operated movie. The movie information input to the movie information input unit 201 and held in the movie information holding unit 204 is obtained from the movie information (FIG. 5) using the obtained ID 301 or the like, and the obtained movie information and the information on the operation by the user are registered while being related.

Next, an example of the recommendation calculation result calculated by the recommendation calculating unit 210 and held in the recommendation result holding unit 207 is described.

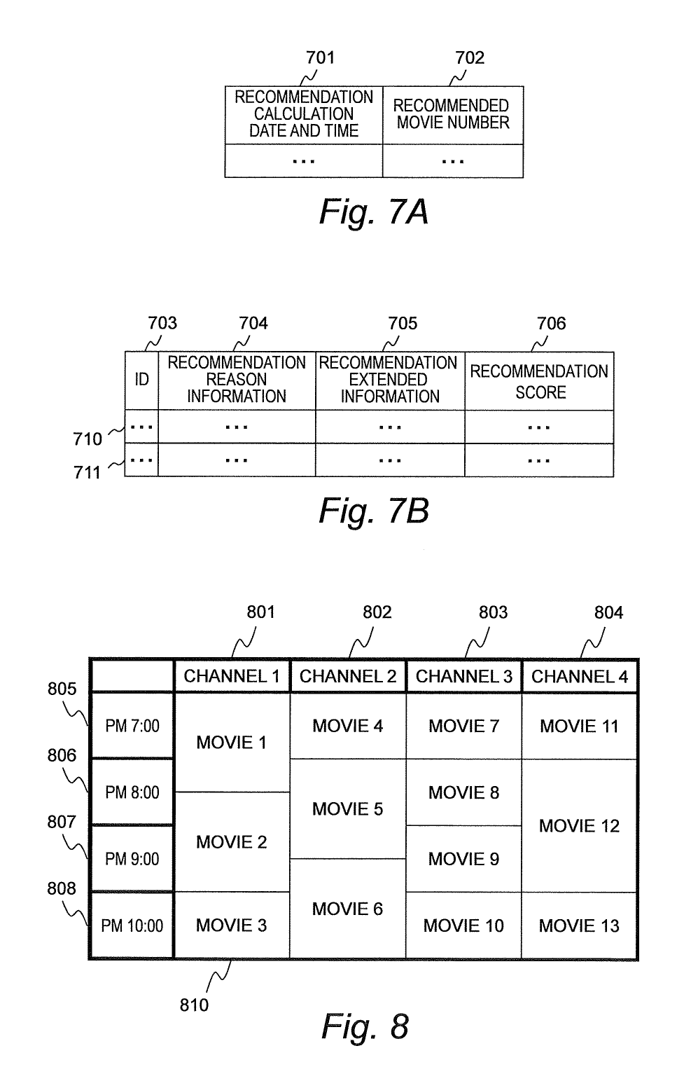

FIGS. 7A and 7B are tables showing examples of the recommendation calculation result according to this embodiment. FIG. 7A shows header information of the recommendation result and the header information is set for each recommendation result. FIG. 7B shows information on the respective recommendation target movies which is structured to follow the header information (FIG. 7A).

The header information (FIG. 7A) includes a recommendation calculation date 701 and a recommendation movie number 702.

The recommendation calculation date 701 is a date on which the recommendation calculation was performed and may be a date on which the generation of the recommendation result calculated in the recommendation calculating unit 210 was completed.

The recommendation movie number 702 is the number of the recommendation target movies and included in the recommendation result calculated in the recommendation calculating unit 210, i.e. the number of entries 710, 711 of the recommendation movies included in the information on the recommendation target movies (FIG. 7B).

The information on the recommendation target movies (FIG. 7B) includes an ID 703, recommendation reason information 704, recommendation extended information 705 and a recommendation score 706.

The ID 703 is an identifier of the recommendation target movie and the same identifier as the ID 301 in the movie information (FIG. 5) is used as such.

The recommendation reason information 704 is a recommendation reason for the movie and, for example, data indicating information on determination as a program to be recommended out of the genre, the day of week, the time, the movie length, the title, the content, the detailed information and a combination of these included in the user log. For example, 8-bit data each bit of which is allotted to information serving as a recommendation reason may be used.

The recommendation extended information 705 is information complementing the recommendation reason information 704. For example, in a case where the recommendation reason is the “detailed information”, a keyword for determination of a program to be recommended out of the detailed information may be stored.

For example, in a case where the user has operated many movies in which a specific actor included in the detailed information appears, the bit indicating the “detailed information” is set in the recommendation reason information 704 and the actor name included in the detailed information may be stored in the recommendation extended information 705. In this way, the recommendation reason for the movie can be presented to the user, for example, in presenting the recommendation movie to the user.

The recommendation score 706 is a score indicating a recommendation degree of the recommendation target movie, and the recommendation score of the movie calculated by the recommendation calculating unit 210 is stored. A matching degree with the operation logs of the user calculated, for example, in the simple recommendation calculating unit 231 or the extended recommendation calculating unit 232 to be described later is calculated and the scored matching degree is stored as the recommendation score 706.

It should be noted that although the pieces of information shown in FIGS. 3 to 7B are shown in table formats, they may be held in other formats in the storage unit.

Next, an example of a result generated and output by the movie recommendation system of this embodiment, i.e. a display screen to be presented to the user is described.

First, an example of the movie selection screen generated by the movie selection screen generating unit 213 is described. The movie selection screen is a screen used by the user to select a favorite movie in a case where the number of the operation logs held in the log holding unit 203 is equal to or smaller than a predetermined number when the output of a recommendation calculation result is requested to the recommendation control unit 205 from the recommendation output instructing unit 206.

A threshold value of the number of the operation logs held in the log holding unit 203 may be 0 or a predetermined number equal to or larger than 1. That is, it is detected that even one operation log is not held in the log holding unit 203 in a case where the threshold value is set at 0, whereas it is detected that a small number of operation logs are held in the log holding unit 203 in a case where the threshold value is set at the predetermined number equal to or larger than 1.

It should be noted that movies as selection targets by the user are not particularly limited to television programs, but are all the movies viewable by the user. However, to facilitate description, a case of selecting a television broadcast program is described.

FIG. 8 is a table showing an example of the movie selection screen generated by the movie selection screen generating unit 213 according to this embodiment.

It should be noted that a signal used to write this movie selection screen in a video RAM or the like or display it on a screen of a television receiver or a personal computer may be generated by the selection screen output device 108. Further, the movie may be selected from the movie selection screen, for example, by the selection information input device 109, e.g. a remote controller or a mouse, and the input of the movie information on the movie selected by the user may be received by the selected movie information input unit 214.

The movie selection screen shown in FIG. 8 includes channels (801 to 804) of movies viewable, recordable, reproducible and/or programmable by the user on a horizontal axis and hours (805 to 808), during which the movies are viewable, on a vertical axis. Movies 810 are information on movies viewable on the channels (801 to 804) during the hours (805 to 808).

The movie selection screen of this embodiment displays the information on the movies viewable, recordable, reproducible and/or programmable by the user, as an example, in a television program table format (radio/television columns) as shown in FIG. 8, thereby urging the user to select a favorite movie. However, any fog mat may be adopted provided that it can display the information on the movies viewable, recordable, reproducible and/or programmable by the user. It should be noted that the movie information is the one input to the movie information input unit 201 described above. Particularly, by using the basic information input by the movie basic information input unit 211 described above, the movie selection screen can be quickly generated without waiting for a time to obtain the extended information.

Next, an output example of the recommendation calculation result calculated by the recommendation calculating unit 210 and held in the recommendation result holding unit 207 is described. This recommendation calculation result is output from the recommendation output unit 208 (recommendation result output device 103) and presented to the user in response to an instruction input to the recommendation output instructing unit 206 (recommendation output instructing device 107).

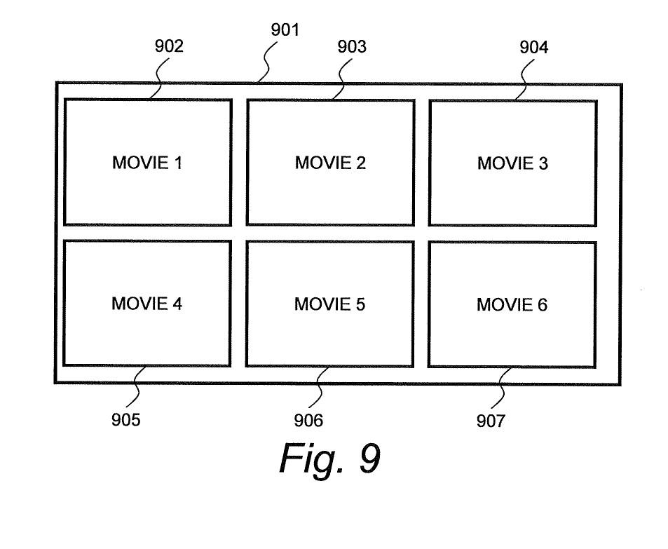

FIG. 9 is a diagram showing an example of a display screen for the recommendation calculation result according to this embodiment.

A display screen 901 for the recommendation calculation result includes an area for displaying the movie information. Information 901 to 906 on movies 1 to 6 is displayed in this area. The movie information is the one input to the movie information input unit 201. The information on the movie having the same ID as the ID 703 included in the recommendation calculation result (FIG. 7B) may be obtained from the movie information holding unit 204 and the obtained text information may be displayed. Further, thumbnail images may be displayed for movies broadcast or delivered in the past.

Further, a recommendation reason and a recommendation score may be displayed. The recommendation reason can be obtained from the recommendation reason information 704 and the recommendation extended information 705 included in the recommendation calculation result (FIG. 7B). For example, in a case where the bit indicating the detailed information is set in the recommendation reason information 704, a keyword (e.g. XXX) may be obtained from the recommendation extended information 705 and a message “XXX is included in detailed information” may be displayed.

The recommendation score can be obtained from the recommendation score 706 of the recommendation calculation result (FIG. 7B) and a numerical value of this score, a mark (e.g. star(s)) corresponding to the score or the like may be displayed. It should be noted that although all the pieces of information on the recommendation movies are displayed in the same size in FIG. 9, the movie information (e.g. characters, display columns) may be displayed with the size thereof changed according to the recommendation score (e.g. in a decreasing order of the recommendation score).

The movie information (e.g. characters, display columns) may be displayed with the size thereof changed.

Next, the operation of the movie recommendation system of this embodiment is described.

The movie recommendation system of this embodiment is controlled by the recommendation control unit 205 and particularly performs a recommendation calculation when the recommendation control unit 205 receives an event from the timer 209 and outputs a recommendation result when the recommendation control unit 205 receives an event from the recommendation output instructing unit 206. Thus, these respective processes are described.

First, the recommendation calculation process when the recommendation control unit 205 receives an event from the timer 209 is described.

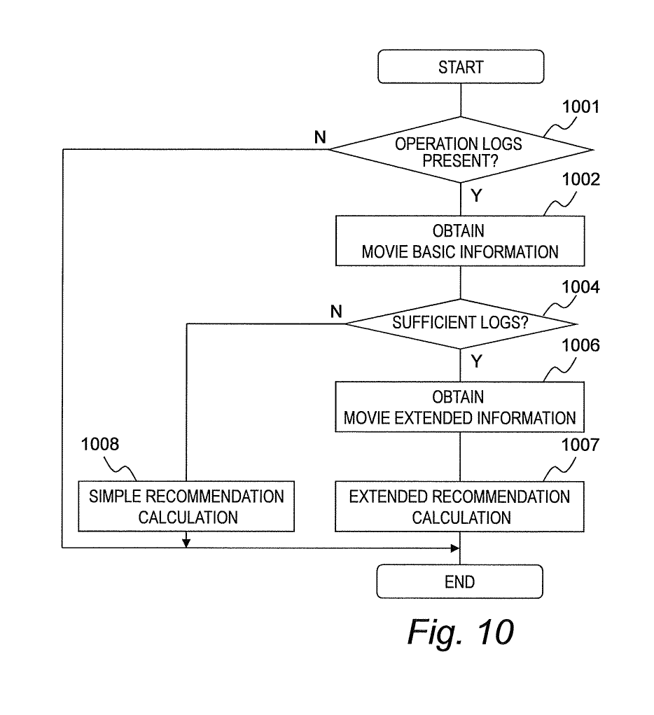

FIG. 10 is a flow chart of the recommendation calculation process according to this embodiment.

When receiving an event from the timer 209, the recommendation control unit 205 determines whether or not any operation log of the user is held in the log holding unit 203 (Step 1001). As a result, the recommendation calculation process ends without doing anything in a case where it is determined that no operation log is held in the log holding unit 203, i.e. even one operation log of the user is not registered in the log holding unit 203 (“N” in Step 1001).

On the other hand, in a case where log registration is determined, i.e. it is determined that the operation log of the user is held in the log holding unit 203 (“Y” in Step 1001), the recommendation control unit 205 obtains the basic information on movies by receiving the basic information on the movies viewable, recordable, reproducible and/or programmable by the user from the movie basic information input unit 211 (Step 1002). The basic information input to the movie basic information input unit 211 is held in the movie basic information holding unit 221.

Subsequently, the recommendation control unit 205 compares the number of the operation logs held in the log holding unit 203 and a predetermined threshold value (Step 1004). As a result, in a case where the number of the operation logs held in the log holding unit 203 is equal to or smaller than the predetermined threshold value and determined to be insufficient (“N” in Step 1004), the recommendation control unit 205 instructs the simple recommendation calculating unit 231 to perform a recommendation calculation using the basic information obtained in Step 1002 and the operation logs held in the log holding unit 203 (Step 1008). The simple recommendation calculating unit 231 performs the recommendation calculation and writes a recommendation calculation result in the recommendation result holding unit 207. It should be noted that a specific recommendation calculation method by the simple recommendation calculating unit 231 is described later. Thereafter, the recommendation calculation process ends.

In this way, whether the recommendation calculation is performed by the simple recommendation calculating unit 231 or by the extended recommendation calculating unit 232 is determined based on the number of the operation logs held in the log holding unit 203. The predetermined threshold value to be compared with the number of the operation logs is a number capable of determining the user's tastes by the comparison of the operation logs and the movie information and, specifically, may be from several to several tens.

This is because the recommendation calculation result varies in a case where the recommendation calculation is performed using the extended information in a case where a small number of operation logs are held in the log holding unit 203. That is, movies to be recommended cannot be narrowed down in a state where there are a small number of operation logs, and a result not properly reflecting the user's tastes (i.e. noise) is included in the recommendation calculation result to degrade the accuracy of the recommendation result.

On the other hand, in a case where it is determined that the number of the operation logs held in the log holding unit 203 is larger than the predetermined threshold value and determined to be sufficient (“Y” in Step 1004), the extended information is obtained by inputting the extended information on the movies viewable, recordable, reproducible and/or programmable by the user from the movie extended information input unit 212 (Step 1006). The extended information input to the movie extended information input unit 212 is held in the movie extended information holding unit 222.

Subsequently, the recommendation control unit 205 instructs the extended recommendation calculating unit 232 to perform a recommendation calculation using the movie information including the basic information obtained in Step 1002 and the extended information obtained in Step 1006 and the operation logs held in the log holding unit 203 (Step 1007). The extended recommendation calculating unit 232 performs the recommendation calculation and writes a recommendation calculation result in the recommendation result holding unit 207. It should be noted that a specific recommendation calculation method by the extended recommendation calculating unit 232 is described later. Thereafter, the recommendation calculation process ends.

It should be noted that the movie information is a combination of the basic information and the extended information as shown in FIG. 5 and may be generated by the movie information input unit 201 and held in the movie information holding unit 204.

Next, a recommendation result output process when the recommendation control unit 205 receives an event from the recommendation output instructing unit 206 is described.

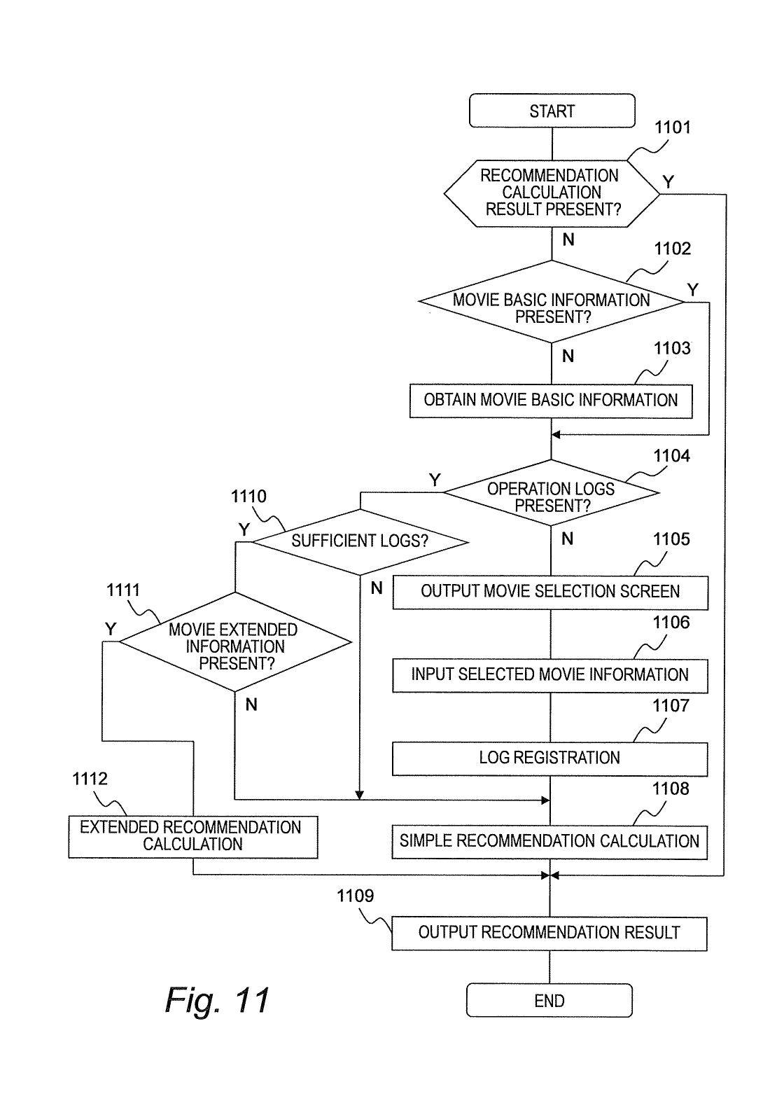

FIG. 11 is a flow chart of the recommendation result output process according to this embodiment.

When receiving an event from the recommendation output instructing unit 206, the recommendation control unit 205 first determines whether or not a new recommendation calculation result is held in the recommendation result holding unit 207 (Step 1101). It should be noted that whether or not the recommendation calculation result held in the recommendation result holding unit 207 is the recent one can be, for example, determined as follows. The recommendation calculation date 701 included in the header information (FIG. 7A) of the recommendation result and the current date are compared and the recommendation calculation result can be determined to be new in a case where a date difference is within 2 days.

As a result, the recommendation control unit 205 outputs the recommendation result held in the recommendation result holding unit 207 via the recommendation output unit 208, i.e. from the recommendation result output device 103 in a case where a new recommendation calculation result is held in the recommendation result holding unit 207 (“Y” in Step 1101).

On the other hand, in a case where no new recommendation calculation result is held in the recommendation result holding unit 207 (“N” in Step 1101), the recommendation control unit 205 further determines whether or not the basic information on the movies viewable, recordable, reproducible and/or programmable by the user is held in the movie basic information holding unit 221 (Step 1102). As a result, the recommendation control unit 205 obtains the basic information by the input of the basic information on the movies viewable, recordable, reproducible and/or programmable by the user from the movie basic information input unit 211 (Step 1103) in a case where the basic information is not held in the movie basic information holding unit 221 (“N” in Step 1102). The basic information input to the movie basic information input unit 211 is held in the movie basic information holding unit 221.

On the other hand, in a case where the basic information is held in the movie basic information holding unit 221 (“Y” in Step 1102), no basic information is obtained in Step 1103 since the basic information held in the movie basic information holding unit 221 can be used.

Subsequently, the recommendation control unit 205 determines whether or not any operation log of the user is held in the log holding unit 203 (Step 1104). This determination may be made by determining whether or not no operation log is held in the log holding unit 203 or, in a case where the number of the operation logs held in the log holding unit 203 is equal to or smaller than a predetermined number, it may be determined that no operation log is held in the log holding unit 203.

As a result, a movie selection screen (FIG. 8) is generated by the movie selection screen generating unit 213 and output from the selection screen output device 108 (Step 1105) in a case where it is determined that no operation log is held in the log holding unit 203, i.e. it is detected that even one operation log of the user is not registered in the log holding unit 203 (“N” in Step 1104).

Subsequently, the recommendation control unit 205 receives the input of the information on the movie selected on the movie selection screen by the user from the selected movie information input unit 214 via the selection information input device 109 (Step 1106). It should be noted that information on a plurality of movies may be made selectable instead of selecting the information on one movie.

Further, the recommendation control unit 205 performs log registration by holding the movie information input by the user as the operation log in the log holding unit 203 (Step 1107). This registered operation log may be distinguished as a selection log of the movie on the movie selection screen by the user from other operation logs of viewing, recording, reproducing and/or programming. Specifically, a numerical value (or character string) indicating a selection screen selection may be stored in the log type 602 of the operation log (FIG. 6). This enables a high-accuracy recommendation calculation by tentatively performing a recommendation calculation with the log selected on the movie selection screen by the user excluded in a case where there is any operation log of actually viewing, recording, reproducing and/ or programming a movie.

Subsequently, the recommendation control unit 205 instructs the simple recommendation calculating unit 231 to perform a recommendation calculation using the basic information held in the movie basic information holding unit 221 and the operation log held in the log holding unit 203 (Step 1108). The simple recommendation calculating unit 231 performs the recommendation calculation and writes a recommendation calculation result in the recommendation result holding unit 207. It should be noted that a specific recommendation calculation method by the simple recommendation calculating unit 231 is described later.

Thereafter, the recommendation control unit 205 instructs the recommendation output unit 208 to output the recommendation result (Step 1109). Then, the recommendation output unit 208 outputs the recommendation result held in the recommendation result holding unit 207 from the recommendation result output device 103.

On the other hand, in a case where the presence of the log registration is detected, i.e. it is detected that the operation logs of the user are held in the log holding unit 203 (“Y” in Step 1104), the recommendation control unit 205 compares the number of the operation logs held in the log holding unit 203 and a predetermined threshold value (Step 1110). This predetermined threshold value may be the same as or different from the predetermined number used in determining the presence or absence of the operation log in Step 1104 described above.

As a result, in a case where the number of the operation logs held in the log holding unit 203 is equal to or smaller than the predetermined threshold value and determined to be insufficient (“N” in Step 1110), the process proceeds to Step 1108 and the recommendation control unit 205 instructs the simple recommendation calculating unit 231 to perform a recommendation calculation using the basic information held in the movie basic information holding unit 221 and the operation logs held in the log holding unit 203 (Step 1108). The simple recommendation calculating unit 231 performs the recommendation calculation and writes a recommendation calculation result in the recommendation result holding unit 207. It should be noted that the specific recommendation calculation method by the simple recommendation calculating unit 231 is described later.

Thereafter, the recommendation control unit 205 instructs the recommendation output unit 208 to output the recommendation result (Step 1109). Then, the recommendation output unit 208 outputs the recommendation result held in the recommendation result holding unit 207 from the recommendation result output device 103.

On the other hand, in a case where the number of the operation logs held in the log holding unit 203 is larger than the predetermined threshold value and deter mined to be sufficient (“Y” in Step 1110), the recommendation control unit 205 further determines whether or not the extended information on the movies viewable, recordable, reproducible and/or programmable by the user is held in the movie extended information holding unit 222 (Step 1111).

As a result, in a case where no extended information is held in the movie extended information holding unit 222 (“N” in Step 1111), the process proceeds to Step 1108 and the recommendation control unit 205 instructs the simple recommendation calculating unit 231 to perform a recommendation calculation using the basic information held in the movie basic information holding unit 221 and the operation logs held in the log holding unit 203 (Step 1108). The simple recommendation calculating unit 231 performs the recommendation calculation and writes a recommendation calculation result in the recommendation result holding unit 207. It should be noted that the specific recommendation calculation method by the simple recommendation calculating unit 231 is described later.

Thereafter, the recommendation control unit 205 instructs the recommendation output unit 208 to output the recommendation result (Step 1109). Then, the recommendation output unit 208 outputs the recommendation result held in the recommendation result holding unit 207 from the recommendation result output device 103.

On the other hand, in a case where the extended information is held in the movie extended information holding unit 222 (“Y” in Step 1111), the recommendation control unit 205 instructs the extended recommendation calculating unit 232 to perform a recommendation calculation using the movie information including the basic information held in the movie basic information holding unit 221 and the extended information held in the movie extended information holding unit 222 and the operation logs held in the log holding unit 203 (Step 1112). The extended recommendation calculating unit 232 performs the recommendation calculation and writes a recommendation calculation result in the recommendation result holding unit 207. It should be noted that a specific recommendation calculation method by the extended recommendation calculating unit 232 is described later. Therefore the recommendation calculation process ends

Thereafter, the recommendation control unit 205 instructs the recommendation output unit 208 to output the recommendation result (Step 1109). Then, the recommendation output unit 208 outputs the recommendation result held in the recommendation result holding unit 207 from the recommendation result output device 103.

It should be noted that the movie information is a combination of the basic information and the extended information as shown in FIG. 5 and may be generated by the movie information input unit 201 and held in the movie information holding unit 204.

That is, in the recommendation result output process described above, there are three options sorted according to a log accumulated state.

(1) In a case where a very small number of operation logs are accumulated (e.g. 0 operation log), the user is made to select on the movie selection screen (Steps 1106, 1107) and a simple recommendation calculation is performed (Step 1108).

(2) In a case where the accumulated operation logs are insufficient (e.g. several operation logs) or the movie extended information is not obtained, a simple recommendation calculation is performed (Step 1108).

(3) In a case where the operation logs are sufficiently accumulated (e.g. several tens of operation logs) and the movie extended information is obtained, an extended recommendation calculation is performed (Step 1112).

Next, an example of the recommendation calculation method by the simple recommendation calculating unit 231 and an example of a specific recommendation calculation method by the extended recommendation calculating unit 232 are described.

First, an example of a specific recommendation calculation method by the simple recommendation calculating unit 231 is described.

The simple recommendation calculating unit 231 calculates the recommendation score of each movie (e.g. movie viewable, recordable, reproducible and/or programmable by the user), the basic information of which is held in the movie basic information holding unit 221, using the basic information held in the movie basic information holding unit 221 (i.e. basic information on the movies viewable, recordable, reproducible and/or programmable by the user) and the operation logs of the user held in the log holding unit 203.

Specifically, the simple recommendation calculating unit 231 calculates a matching degree between the basic information held in the movie basic information holding unit 221 and the information on the movies included in the operation logs held in the log holding unit 203 (i.e. movies operated by the user), and calculates the recommendation score of each movie based on the calculated matching degree.

This is, for example, performed as follows. One piece of the basic information held in the movie basic information holding unit 221 is obtained, the operation logs held in the log holding unit 203 are obtained one by one, and it is determined whether or not the time (303 in FIGS. 5 and 6), the day of week (304 in FIGS. 5 and 6), the movie length (305 in FIGS. 5 and 6), the genre (306 in FIGS. 5 and 6) and the title (307 in FIGS. 5 and 6) respectively match. As a result, in a case where it is determined that the basic information and the operation log are determined to match, a specified score corresponding to the number of the matching items may be added as the recommendation score for the movie indentified by the ID 301 of this basic information. This match determination is successively performed for all the pieces of the basic information.

In the case of determining the match between the basic information and the operation log, the respective items may not perfectly match and a match may be determined in a case where they only partially match or slightly differ. In other words, ambiguous matches may be allowed. For example, for the title, in a case where the character string of the title does not perfectly match, a match may be determined in a case where main words match.

Further, an added value of the score may be weighted according to the items and the matching degree.

Further, also for the content (308 in FIGS. 5 and 6), a recommendation score may be added according to the number of matching words in a descriptive text showing the content. Then, the bit of the recommendation reason information 704 corresponding to the item determined to match may be set and the recommendation calculation result (FIG. 7B) may be generated by listing the matching words in the recommendation extended information 705.

It should be noted that the movies having high recommendation scores become recommendation movies. For example, in a case where the movies are listed in a decreasing order of the score, the movies having a predetermined score or above, a predetermined number of the movies having high score, or the movies up to the one having a large score difference from the movie listed right above are registered as the recommendation movies in the recommendation calculation result (FIG. 7B), and the date on which the recommendation calculation is performed and the number of the recommendation movies are respectively stored as the recommendation calculation date 701 and the recommendation movie number 702 of the header information (FIG. 7A) of the recommendation result, whereby the recommendation result can be obtained.

Next, a specific recommendation calculation method by the extended recommendation calculating unit 232 is described.

The extended recommendation calculating unit 232 calculates the recommendation score of each movie (e.g. movie viewable, recordable, reproducible and/or programmable by the user), the information of which is held in the movie information holding unit 204, using the movie information held in the movie information holding unit 204 (i.e. information on the movies viewable, recordable, reproducible and/or programmable by the user) and the operation logs of the user held in the log holding unit 203. Here, the movie information held in the movie information holding unit 204 is a combination of the basic information input to the movie basic information input unit 211 and held in the movie basic information holding unit 221 and the extended information input to the movie extended information input unit 212 and held in the movie extended information holding unit 222 as shown in FIG. 5.

Specifically, the extended recommendation calculating unit 232 calculates a matching degree between the movie information held in the movie information holding unit 204 and the information on the movies included in the operation logs held in the log holding unit 203 (i.e. movies operated by the user), and calculates the recommendation score of each movie based on the calculated matching degree.

This is, for example, performed as follows. One piece of the movie information held in the movie information holding unit 204 is obtained one by one, the operation logs held in the log holding unit 203 are obtained one by one, a process similar to the one performed by the simple recommendation calculation unit 231 described above is performed, and a specified score may be added as a recommendation score according to the number of words matching between the operation log held in the log holding unit 203 and the detailed information (401 in FIGS. 5 and 6). This match determination is successively performed for all the pieces of the movie information.

Particularly, since the actor names, director name, producer and the like of the movie are included in the detailed information, only a match of the actor names may be evaluated. Further, since the names of famous actors are displayed at the beginning, only a match of the actor names listed high may be evaluated. Furthermore, scores weighted in the order of displaying these actors may be added. A match may be evaluated for all the items such as the actor names, the director name and the producer and a score weighted for these matches may be added.

Then, similar to the simple recommendation calculation unit 231, the bit of the recommendation reason information 704 corresponding to the item determined to match may be set and the recommendation calculation result (FIG. 7B) may be generated by listing the matching words in the recommendation extended information 705.

It should be noted that the movies having high recommendation scores become recommendation movies. For example, the movies having a predetermined score or above, a predetermined number of the movies high in score or the movies up to the one having a large score difference from the movie listed right above in a case where the movies are listed in a decreasing order of the score are registered as the recommendation movies in the recommendation calculation result (FIG. 7B), and the date on which the recommendation calculation is performed and the number of the recommendation movies are respectively stored as the recommendation calculation date 701 and the recommendation movie number 702 of the header information (FIG. 7A) of the recommendation result, whereby the recommendation result can be obtained.

It should be noted that the recommendation score may be set to 0 for the movies operated by the user in the processes by the simple recommendation calculation unit 231 and the extended recommendation calculation unit 232. For example, in the simple recommendation calculation unit 231, the recommendation score may be set to 0 for the movie for which the ID 301 of the basic information held in the movie basic information holding unit 221 and the ID 301 of the operation log held in the log holding unit 203 match. In this way, it can be prevented to recommend, for example, movies which the user already programmed to record and are already known to the user.

It should be noted that, in the case of preventing movies already known to the user from being recommended, the log input unit 202 may notify an operation log input via the log input device 102 to the recommendation control unit 205 and the recommendation control unit 205 may exclude the movie having the ID 703 identical to the ID 301 included in the input operation log, from the recommendation result.

As described above, according to the embodiment of the present invention, the accuracy of the recommendation calculation can be improved since a simple recommendation calculation is performed in a case where a small number of operation logs are accumulated and an extended recommendation calculation is performed in a case where a large number of operation logs are accumulated. This is because noise not reflecting the user's tastes is included in a recommendation calculation result to degrade the accuracy of a recommendation result in a case where a recommendation calculation is performed using the extended information in a case where a small number of logs are accumulated.

Since a movie selection screen is displayed at least the first time when movie recommendation is requested, an operation can be made easily understandable. Further, since the movie selection screen is displayed using the movie basic information, it can be displayed without making the user wait since the movie basic information can be obtained in a short time.

Further, at the time of the first movie recommendation, the movie selection screen is displayed, a simple recommendation calculation is performed based on information on a selected movie and movie basic information after letting the user select a favorite movie from the movie selection screen, and the recommendation calculation method is switched to an extended recommendation calculation after operation logs of the user are sufficiently accumulated, whereby recommendation accuracy can be ensured and a processing time at the time of the first movie recommendation, i.e. a waiting time of the user can be reduced to improve convenience of the movie recommendation system.

Further, even in a state not connected to a network, suitable movies can be recommended from an initial stage of the operation of the movie recommendation system, wherefore a cost increase on network connection can be suppressed.

Further, when the movie extended information has not been obtained even though the operation logs are accumulated, a simple recommendation calculation is performed, wherefore the user requesting the movie recommendation is not made to wait for a period until the obtainment of the movie extended information is completed.

Furthermore, the last calculation result is used in a case where a new recommendation result is held in the recommendation result holding unit 207, and a new recommendation result is calculated in a case where the recommendation result held in the recommendation result holding unit 207 is old. Thus, movies can be recommended based on new information while the calculation amount is suppressed.

In this way, the movie recommendation system of this embodiment does not require network connection and others' operation logs. Therefore, a movie recommendation function inexpensive and satisfactory to the user can be obtained by reducing system cost.

### Modified Examples

Finally, modified examples of the embodiment described above are described.

(1) In the embodiment described above, the movie selection screen is output to let the user select a favorite movie in a case where the number of the operation logs of the user is small (e.g. 0 or equal to or smaller than the predetermined number) in Step 1104. However, regardless of the presence or absence of the operation logs and the accumulated amount of the operation logs, the recommendation control unit 205 may cause the output of the movie selection screen to let the user select a favorite movie when first receiving an event from the recommendation output instructing unit 206 after the actuation of the movie recommendation system. In this case, if there are already the operation logs of the user, a recommendation calculation process (FIG. 10) may be performed based on the operation logs already held in the log holding unit 203 and a recommendation result may be output in a case where the user does not select a favorite movie. Further, when the user selects a favorite movie, the recommendation calculation process (FIG. 10) may be performed and the recommendation result may be output after information on the movie selected by the user is added to the operation logs already held in the log holding unit 203. In this case, the simple recommendation calculation by the simple recommendation calculation unit 231 (Step 1108) or the extended recommendation calculation by the extended recommendation calculation unit 232 (Step 1112) may be constantly performed without performing the recommendation calculation process (FIG. 10).

(2) When the movie selection screen is output when an event is first received from the recommendation output instructing unit 206 after the actuation of the movie recommendation system of this embodiment, the movie selection screen may be output regardless of whether or not a new recommendation calculation result is held in the recommendation result holding unit 207 (Step 1101). In this case, if the recommendation calculation result is held in the recommendation result holding unit 207, the recommendation calculation result held in the recommendation result holding unit 207 may be output or the recommendation calculation may be performed anew.

Further, in a case where the operation logs of the user are held in the log holding unit 203, the recommendation calculation process (FIG. 10) may be performed using the operation logs of the user already held in the log holding unit 203 and the recommendation result may be output even if the user does not select a favorite movie.

In a case where the user selects a favorite movie, the recommendation calculation process (FIG. 10) may be performed and the recommendation result may be output after information on the movie selected by the user is added to the operation logs already held in the log holding unit 203. In this case, the simple recommendation calculation by the simple recommendation calculation unit 231 (Step 1108) or the extended recommendation calculation by the extended recommendation calculation unit 232 (Step 1112) may be constantly performed without performing the recommendation calculation process (FIG. 10).

It should be noted that in a case where the movie selection screen is output when an event is first received from the recommendation output instructing unit 206 after the actuation of the movie recommendation system and if the basic information and the extended information on the movies are already obtained in the first recommendation calculation, these pieces of information may not be obtained anew.

(3) In a case where the movie selection screen is output when an event is first received from the recommendation output instructing unit 206 after the actuation of the movie recommendation system, the recommendation calculation process (FIG. 10) may not be performed until the movie selection screen is output and the user selects a movie. Specifically, the timer 209 may not be operated until the movie selection screen is output and a movie is selected by the user.

By preventing the recommendation calculation until the user selects a movie in this way, the processing amount of equipment including the movie recommendation system can be reduced and power consumption can be reduced by not performing a calculation for recommending movies to users who do not use the recommendation function.

(4) In a case where no movie is selected by the user in inputting the selected movie information (Step 1106 of FIG. 11), the movie selection screen may be continuously output until a movie is selected.

The present invention is applicable to equipment capable of viewing, recording, reproducing and/or programming movies and can be applied, for example, to television receivers, personal computers, image recorders (hard disk recorders), mobile phones, mobile media players and the like.

While the present invention has been described in detail and pictorially in the accompanying drawings, the present invention is not limited to such detail but covers various obvious modifications and equivalent arrangements, which fall within the purview of the appended claims.

What is claimed is:

1. A movie recommendation system for recommending movies to a user, comprising:
a log holding unit for holding at least one operation log of viewing, recording, reproducing and programming by the user on a movie;
a movie information input unit for receiving the input of information on movies operable by the user; and
a recommendation calculation unit for calculating recommendation movies to be recommended to the user based on the operation logs held in the log holding unit and movie information input to the movie information input unit; wherein:
the movie information input unit includes a movie basic information input unit for receiving the input of basic information on the movies operable by the user and a movie extended information input unit for receiving the input of extended information on the movies operable by the user;
the recommendation calculation unit includes a simple recommendation calculation unit for calculating recommendation movies based on the basic information input to the movie basic information input unit and an extended recommendation calculation unit for calculating recommendation movies based on the extended information input to the movie extended information input unit; and
the movie recommendation system is configured to:
compare the number of the operation logs held in the log holding unit and a predetermined value,
calculate the recommendation movies by the simple recommendation calculation unit in a case where it is determined that a small number of operation logs are held in the log holding unit, and
calculate the recommendation movies by the extended recommendation calculation unit in a case where it is determined that a large number of operation logs are held in the log holding unit.

2. The movie recommendation system according to claim 1, further comprising:
a movie selection screen generating unit for generating a movie selection screen for selection of a favorite movie by the user based on the basic information input to the movie basic information input unit;
a selected movie information input unit for receiving the input of information on the movie selected by the user in accordance with the generated movie selection screen;
a recommendation output instructing unit for instructing the output of information on the recommendation movies calculated by the recommendation calculating unit; and
a recommendation output unit for outputting the information on the recommendation movies calculated by the recommendation calculation unit based on an instruction from the recommendation output instructing unit, wherein:
the movie selection screen generating unit generates the movie selection screen for selection of a favorite movie by the user in a case where it is determined that a small number of operation logs are held in the log holding unit when the output of the recommendation movies is instructed by the recommendation output instructing unit;
the selected movie information input unit receives the input of the information on the movie selected by the user;
the simple recommendation calculation unit calculates the recommendation movies based on the information on the selected movie; and
the recommendation output unit outputs information on the recommendation movies calculated by the simple recommendation calculation unit.

3. The movie recommendation system according to claim 2, wherein the movie selection screen generating unit outputs the generated movie selection screen until one or more pieces of information on the movie selected by the user is input to the selected movie information input unit.

4. The movie recommendation system according to claim 1, further comprising:
a movie selection screen generating unit for generating a movie selection screen for selection of a favorite movie by the user based on the basic information input to the movie basic information input unit;
a selected movie information input unit for receiving the input of information on the movie selected by the user in accordance with the generated movie selection screen;
a recommendation output instructing unit for instructing the output of information on the recommendation movies calculated by the recommendation calculating unit; and
a recommendation output unit for outputting the information on the recommendation movies calculated by the recommendation calculation unit based on an instruction from the recommendation output instructing unit, wherein:
the movie selection screen generating unit generates the movie selection screen for selection of a favorite movie by the user when the recommendation output instructing unit first instructs the output of the recommendation movies;
the selected movie information input unit receives the input of the information on the movie selected by the user;
the simple recommendation calculation unit calculates the recommendation movies based on the information on the selected movie; and
the recommendation output unit outputs information on the recommendation movies calculated by the simple recommendation calculation unit.

5. The movie recommendation system according to claim 4, wherein the recommendation calculating unit calculates the recommendation movies after the recommendation output instructing unit instructs the output of information on the recommendation movies and the movie selection screen generating unit generates the movie selection screen.

6. The movie recommendation system according to claim 1, wherein the predetermined value to be compared with the number of the operation logs is a number capable of determining the user's tastes by the comparison of the operation logs and the movie information.

7. The movie recommendation system according to claim 1, wherein the basic information and the extended information differ in at least one of transmission interval and data amount.

8. A movie recommendation method executed in a movie recommendation system for recommending movies to a user, the movie recommendation system including:
a control unit for controlling the movie recommendation system;
a log holding unit for holding at least one operation log of viewing, recording, reproducing and programming by the user on a movie;
a movie information input unit for receiving the input of information on movies operable by the user; and
a recommendation calculating unit for calculating recommendation movies to be recommended to the user based on the operation logs held in the log holding unit and movie information input to the movie information input unit;
the movie information input unit including a movie basic information input unit for receiving the input of basic information on the movies operable by the user and a movie extended information input unit for receiving the input of extended information on the movies operable by the user; and
the recommendation calculation unit including a simple recommendation calculation unit for calculating recommendation movies based on the basic information input to the movie basic information input unit and an extended recommendation calculation unit for calculating recommendation movies based on the extended information input to the movie extended information input unit;
the method including the steps of:
comparing, by the control unit, the number of operation logs held in the log holding unit and a predetermined value;
calculating, by the simple recommendation calculating unit, the recommendation movies in a case where it is determined that a small number of operation logs are held in the log holding unit; and
calculating, the extended recommendation calculating unit, the recommendation movies in a case where it is determined that a large number of operation logs are held in the log holding unit.

9. The movie recommendation method according to claim 8, wherein:
the movie recommendation system further includes:
a movie selection screen generating unit for generating a movie selection screen for selection of a favorite movie by the user based on the basic information input to the movie basic information input unit;
a selected movie information input unit for receiving the input of information on the movie selected by the user in accordance with the generated movie selection screen;
a recommendation output instructing unit for requesting the output of information on the recommendation movies calculated by the recommendation calculating unit; and
a recommendation output unit for outputting the information on the recommendation movies calculated by the recommendation calculation unit based on an instruction from the recommendation output instructing unit; and
the method further includes the steps of:
generating, by the movie selection screen generating unit, the movie selection screen for selection of a favorite movie by the user in a case where it is determined that a small number of operation logs are held in the log holding unit when the output of the recommendation movies is instructed by the recommendation output instructing unit;
receiving, by the selected movie information input unit, the input of the information on the movie selected by the user;
calculating, by the simple recommendation calculation unit, the recommendation movies based on the information on the selected movie; and
outputting, by the recommendation output unit, information on the recommendation movies calculated by the simple recommendation calculation unit.

10. The movie recommendation method according to claim 9, further including the step of outputting, by the movie selection screen generating unit, the generated movie selection screen until the selected movie information input unit receives one or more pieces of information on the movie selected by the user.

11. The movie recommendation method according to claim 8, wherein:
the movie recommendation system further includes:
a movie selection screen generating unit for generating a movie selection screen for selection of a favorite movie by the user based on the basic information input to the movie basic information input unit;
a selected movie information input unit for receiving the input of information on the movie selected by the user in accordance with the generated movie selection screen;
a recommendation output instructing unit for requesting the output of information on the recommendation movies calculated by the recommendation calculating unit; and
a recommendation output unit for outputting the information on the recommendation movies calculated by the recommendation calculation unit based on an instruction from the recommendation output instructing unit; and
the method further includes the steps of:
generating, by the movie selection screen generating unit, the movie selection screen for selection of a favorite movie by the user when the output of the recommendation movies is first requested to the recommendation output instructing unit;
receiving, by the selected movie information input unit, the input of the information on the movie selected by the user;
calculating, by the simple recommendation calculation unit, the recommendation movies based on the information on the selected movie; and
outputting, by the recommendation output unit, information on the recommendation movies calculated.

12. The movie recommendation method according to claim 11, further including the step of calculating, by the recommendation calculating unit, the recommendation movies after the recommendation output instructing unit requests the output of information on the recommendation movies and the movie selection screen generating unit generates the movie selection screen.

13. The movie recommendation method according to claim 8, wherein the predetermined value to be compared with the number of the operation logs is a number capable of determining the user's tastes by the comparison of the operation logs and the movie information.

14. The movie recommendation method according to claim 8, wherein the basic information and the extended information differ in at least one of transmission interval and data amount.
